(19) United States
(12) Patent Application Publication
(10) Pub. No.: US 2004/0017797 A1
(43) Pub. Date: Jan. 29, 2004

(54) Remote data scope

(75) Inventors: Ming-Chuang Chen, Taipei City (TW); Wen-Shuai Liu, Hsintien City (TW)

Correspondence Address: BACON & THOMAS, PLLC, 625 SLATERS LANE, FOURTH FLOOR, ALEXANDRIA, VA, 22314

(73) Assignee: Moxa Technologies Co., Ltd., Taipei (TW)

(21) Appl. No.: 10/253,818

(22) Filed: Sep. 25, 2002

(30) Foreign Application Priority Data
Jul. 25, 2002 (TW) 091116631

(51) Int. Cl. H04J 3/06

(52) U.S. Cl. 370/350

(57) ABSTRACT

A remote data scope by installing a remote monitor equipment and an Ethernet switch in an Ethernet to monitor working status of remote equipments (computers or power generators, etc.) at terminals of the Ethernet. The Ethernet switch includes a packets switching mechanism adapted to copy working status packets of the remote equipments, a processor, a packets conversion mechanism controlled by the processor to convert the format of working status packets from the remote equipments, and communication systems adapted to transmit working status packets from the remote equipments to the packets switching mechanism and formatted working status packets from the packets conversion mechanism to the remote monitor equipment, for enabling the remote monitor equipment to unpack received formatted working status packets so as to obtain working status of the remote equipments.

### BACKGROUND OF THE INVENTION

1. Field of the Invention

The present invention relates to a method of monitoring remote data and, more particularly, to a remote data scope that enables the maintenance engineer to monitor remote equipments through a remote monitor equipment in a far place from remote equipments, for example, in the office.

2. Description of the Related Art

Conventionally, when monitoring working status of a remote equipment (for example, a computer or power generator), the maintenance engineer must carry a monitor equipment, for example, a notebook computer to the job site and then connect the monitor equipment to the remote equipment to be monitored through a cable via a packets switching mechanism. The packets switching mechanism transmits packets data from the equipment under monitoring to the monitor equipment. The monitor equipment unpacks received packets data, so as to obtain actual working status of the equipment under monitoring.

This remote equipment monitoring method has drawbacks. When several equipments at different places are to be monitored, the maintenance engineer will be tired from running around because he (she) must install the monitoring equipment in each place. Further, one maintenance engineer cannot review all the monitor equipment at every place at the same time.

### SUMMARY OF THE INVENTION

The present invention has been accomplished to provide a remote data scope that eliminates the aforesaid drawbacks. It is therefore the main object of the present invention to provide a remote data scope, which enables a person to monitor working status of multiple remote equipments from a remote place at the same time. The remote data scope of the invention is achieved by installing a remote monitor equipment and an Ethernet switch (for example, Ethernet router) in an Ethernet to monitor working status of remote equipments (computers or power generators, etc.) at terminals of the Ethernet. The Ethernet switch comprises a packets switching mechanism adapted to copy working status packets of the remote equipments, a processor, a packets conversion mechanism controlled by the processor to convert the format of working status packets from the remote equipments, and communication systems adapted to transmit working status packets from the remote equipments to the packets switching mechanism and formatted working status packets from the packets conversion mechanism to the remote monitor equipment, for enabling the remote monitor equipment to unpack received formatted working status packets so as to obtain working status of the remote equipments.

### BRIEF DESCRIPTION OF THE DRAWINGS

FIG. 1 is a system block diagram of the present invention (I)

FIG. 2 is a system block diagram of the present invention (II).

FIG. 3 is an operational flow chart of the present invention.

### DETAILED DESCRIPTION OF THE PREFERRED EMBODIMENT

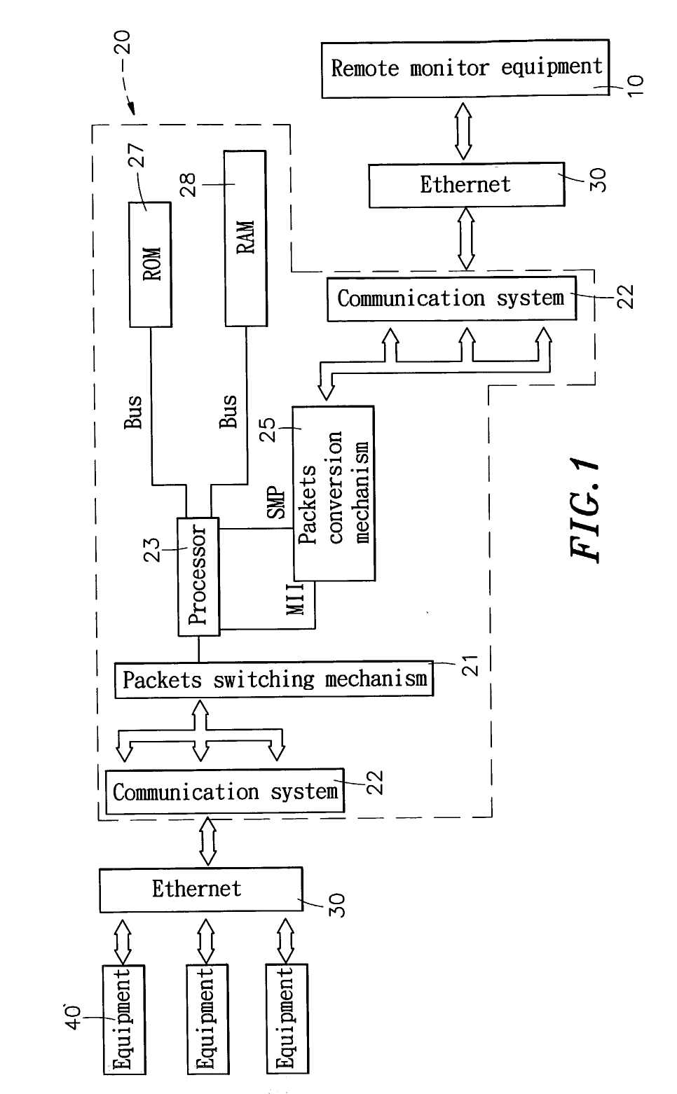

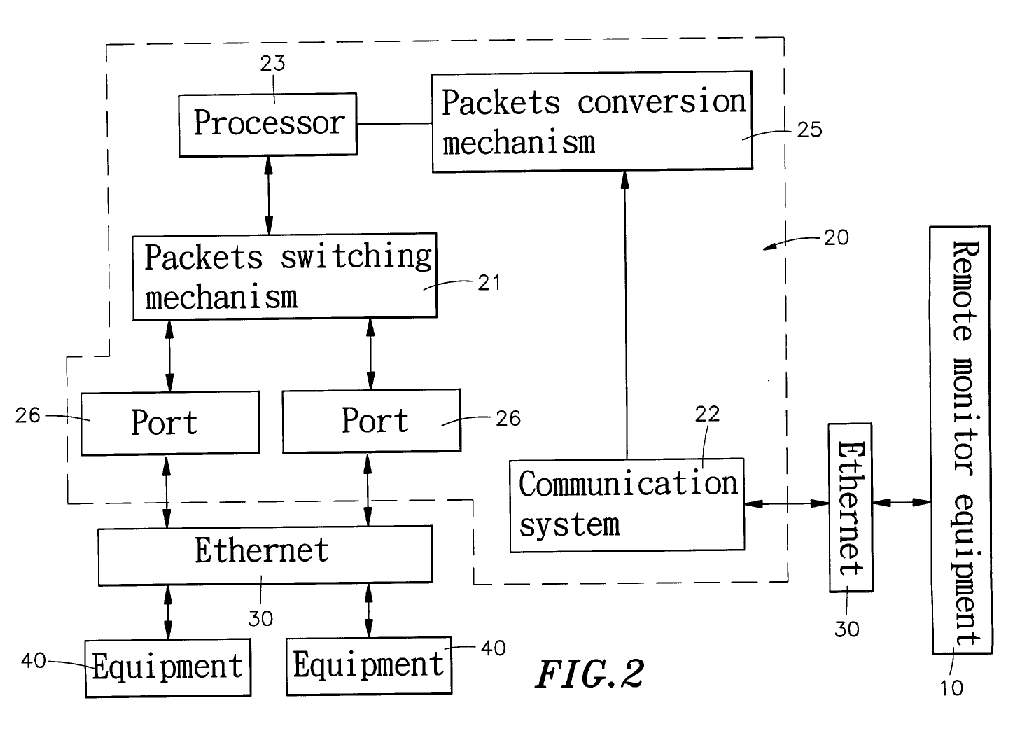

Referring to FIGS. 1 and 2, according to the remote data scope of the invention, a remote monitor equipment (for example, a computer) 10 and an Ethernet switch 20 are installed in an Ethernet 30 and connected to at least one remote equipment (for example, computer, power generator, etc.) 40 through the Ethernet 30. The Ethernet switch 20 comprises a packets switching mechanism 21 adapted to copy working status packets of every remote equipment 40, a processor (CPU) 23, a packets conversion mechanism 25 controlled by the processor 23 to convert the format of working status packets from every remote equipment 40, and communication systems 22 adapted to transmit working status packets from every remote equipment 40 to the packets switching mechanism 21 through the Ethernet 30 and formatted working status packets from the packets conversion mechanism 25 to the remote monitor equipment 10 through the Ethernet 30. The Ethernet switch 20 can be an Ethernet router. The communication systems 22 of the Ethernet switch 20 can be fiber optic converters or twisted-pair cable connectors (RJ45).

Upon receipt of the formatted working status packets from the packets conversion mechanism 25, the remote monitor equipment 10 unpacks the formatted working status packets, so as to obtain the actual working status of every remote equipment 40.

Referring to FIG. 2 again, the Ethernet switch 20 further comprises a plurality of ports 26 respectively connected to the remote equipments 40 and the packets switching mechanism 21, for enabling the packets switching mechanism 21 to copy working status packets from every remote equipment 40.

Referring to FIG. 1 again, the Ethernet switch 20 further comprises a read only memory (for example, flash ROM) 27 and a random access memory (for example, SDRAM) 28 respectively connected to the processor 23 through a respective bus. The processor 23 stores processing data in the random access memory 28 temporarily, and processed storage data in the read only memory 27.

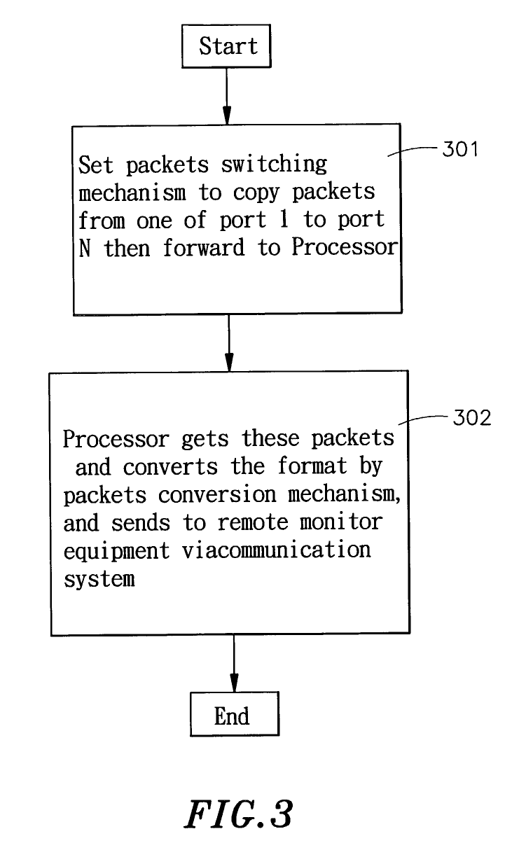

Referring to FIG. 3, when monitoring the remote equipments 40, it proceeds subject to the following steps:

(301) Set the packet switching mechanism 21 to copy packets from the remote equipments 40 one after another in proper order and then forward copied packets to the processor 23;

(302) The processor 23 gets these packets and converts the format by the packets conversion mechanism 25, and then sends formatted packets to the remote monitoring equipment 10 via the Ethernet 30, for enabling the remote monitoring equipment 10 to unpack formatted packets and obtain the working status of every remote equipment 40.

By means of the application of the present invention, the working status packets of every remote equipment are transmitted through communication systems to a remote monitor equipment in the office so that the maintenance engineer can monitor every remote equipment in the office without going to the remote equipment site.

A prototype of remote data scope has been constructed with the features of the annexed drawings of FIGS. 1˜3. The remote data scope functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A remote data scope by installing a remote monitor equipment and an Ethernet switch in an Ethernet to monitor working status of at least one remote equipment at a respective terminal of said Ethernet, wherein said Ethernet switch comprises a packets switching mechanism adapted to copy working status packets of said at least one remote equipment, a processor, a packets conversion mechanism controlled by said processor to convert the format of working status packets from said at least one remote equipment, and communication systems adapted to transmit working status packets from said at least one remote equipment to said packets switching mechanism through said Ethernet and formatted working status packets from said packets conversion mechanism to said remote monitor equipment through said Ethernet, for enabling said remote monitor equipment to unpack received formatted working status packets so as to obtain working status of said at least one remote equipment.

2. The remote data scope as claimed in claim 1, wherein said remote monitor equipment is a computer.

3. The remote data scope as claimed in claim 1, wherein said at least one remote equipment is respectively a computer.

4. The remote data scope as claimed in claim 1, wherein said at least one remote equipment is respectively a power generator.

5. The remote data scope as claimed in claim 1, wherein said Ethernet switch further comprises a plurality of ports respectively connected to said packets switching mechanism and said at least one remote equipment, for enabling said packets switching mechanism to copy working status packets of said at least one remote equipment.

6. The remote data scope as claimed in claim 5, wherein said Ethernet switch further comprises a read only memory and a random access memory respectively connected to said processor, for enabling said processor to store processing data in said random access memory temporarily, and processed storage data in said read only memory.

7. The remote data scope as claimed in claim 6, wherein said read only memory is a flash memory.

8. The remote data scope as claimed in claim 6, wherein said random access memory is a SDRAM.

9. The remote data scope as claimed in claim 1, wherein said communication systems of said Ethernet switch are fiber optic converters.

10. The remote data scope as claimed in claim 1, wherein said communication systems of said Ethernet switch are twisted-pair cable connectors (RJ45).

11. The remote data scope as claimed in claim 1, wherein said Ethernet switch is an Ethernet router.
